(19) United States
(12) Patent Application Publication
(10) Pub. No.: US 2003/0229561 A1
(43) Pub. Date: Dec. 11, 2003

(54) Method and apparatus for converting collectively owned investment accounts and pooled investment accounts and vehicles into individually owned accounts

(75) Inventor: Steven M.H. Wallman, Great Falls, VA (US)

Correspondence Address: MAYER, FORTKORT & WILLIAMS, PC, 251 NORTH AVENUE WEST, 2ND FLOOR, WESTFIELD, NJ, 07090, US

(73) Assignee: FOLIOfn, Inc.

(21) Appl. No.: 10/421,384

(22) Filed: Apr. 23, 2003

Related U.S. Application Data
(60) Provisional application No. 60/375,344, filed on Apr. 25, 2002.

(51) Int. Cl. G06F 17/60

(52) U.S. Cl. 705/36

(57) ABSTRACT

Using an interface to a portfolio manager system, an existing collectively owned investment account can specify its existing assets and a percentage ownership in accounts of each of the individual owners of the collective account. The invention then distributes some or all of the collectively owned assets to some or all of the individual owners in proportion to their ownership interest in the collective account, thereby converting some or all of the collective account into individual accounts. Even if all of the collective account's assets are distributed to the individual owners, the collective account retains a residual-master account, which holds information about the assets, rights or liabilities that were in the collective account. The former managers of the collective account can then continue to manage the residual account and the former owners of the collective account can link the constituents of their individual accounts to the residual account. Each individual who converts his or her interest in the collective account into an individually owned account may continue to receive benefits from association with the collective account. For example, any changes in the residual-master collective account can be transmitted to the investor who may either automatically accept them or who may choose to accept, modify or reject them. In this way, investors may enjoy the benefits of association with the collective account without any of the usual accounting and tax disadvantages, and managers of collective accounts can now distribute their management expertise easily over separate individual accounts.

### RELATED APPLICATIONS

This application claims priority to U.S. Provisional Application No. 60/375,344 filed on Apr. 25, 2002 by the same inventor with the same title.

The present invention is related to U.S. patent application Ser. No. 09/038,158, entitled “Method and Apparatus for Enabling Smaller Investors or Others to Create and Manage a Portfolio of Securities or Other Assets or Liabilities on a Cost Effective Basis,” filed on Mar. 11, 1998. The present invention also is related to U.S. patent application Ser. No. 09/139,020, entitled “Method and Apparatus for Enabling Smaller Investors or Others to Create and Manage a Portfolio of Securities or Other Assets or Liabilities on a Cost Effective Basis,” filed on Aug. 24, 1998. In addition, the present invention is related to U.S. patent application Ser. No. 09/339,299, entitled “Method and System for Investing in a Group of Securities that Are Selected Based on the Aggregated, Individual Preferences of Plural Investors,” filed on Jun. 24, 1999. Furthermore, the present invention is related to U.S. patent application Ser. No. 09/572,694, entitled “On-Line Investment Club,” filed on May 16, 2000. Moreover, the present invention is also related to U.S. Provisional Patent Application No. 60/318,355, entitled “Portfolio Manager With Automated Investment Deselection,” filed Dec. 13, 2001; U.S. Provisional Patent Application No. 60/332,348 entitled “Method and Apparatus For Creating Investment Advice Marketplace,” filed Nov. 15, 2001; U.S. Provisional Patent Application No. 60/332,351 entitled “Method and Apparatus For Providing Investment Advice to Multiple Investors, filed Nov. 15, 2001; U.S. Provisional Patent Application No. 60/333,982 entitled “Method and Apparatus For Rebalancing an Investment Portfolio Using A Portfolio Investment System,” filed Nov. 28, 2001.

Each of these applications was filed by the inventor of the present invention. U.S. patent application Ser. Nos. 09/038,158; 09/139,020; 09/339,299 and 09/572,694 are each hereby incorporated by reference as if repeated herein in their entirety, including the drawings. In addition, U.S. Provisional Patent Application Nos. 60/332,348; 60/332,351; 60/333,982 and 60/318,355 are each hereby incorporated by reference as if repeated herein in their entirety, including the drawings.

### FIELD OF THE INVENTION

The invention described herein relates generally to methods and apparatuses for investing wherein the investments are performed in connection with a collectively owned investment account or a pooled investment account or vehicle, including over computer networks, and including a method and apparatus for investing over a computer network, such as the Internet, wherein the investments are performed in connection with a collectively owned investment account or a pooled investment account or vehicle.

### BACKGROUND OF THE INVENTION

In general, investors may hold their investments in individual accounts or in collectively owned accounts or pooled investment accounts or vehicles. Examples of collectively owned investment accounts include joint accounts, investment clubs, mutual funds, hedge funds, pooled trust accounts or collective trust accounts (all collectively owned accounts or pooled investment accounts or vehicles are referred to herein as “collectively-owned investment accounts”).

Collectively owned investment accounts have certain advantages. Because collectively owned investment accounts pool the investments of more than one investor, they allow individual investors to benefit from certain economies of scale that come with larger investment accounts. For example, some collectively owned investment accounts, such as mutual funds or hedge funds, can afford to hire a professional investment manager to manage the account or, in the case of an investment club, provide a way for a group of investors to make investment decisions together and reduce transaction costs. Also, collectively owned investment accounts may diversify their holdings across a large number of investments, whereas the transaction costs typically associated with purchasing individual investments historically has prevented individual investors from building truly diversified portfolios, especially from the first investment. In addition, collectively owned investment accounts can accept small periodic additional investments from each of the contributing investors and invest those assets cost effectively, whereas individual investors historically have been unable to add small, periodic, additional investments to diversified individual investment accounts in a cost-effective manner.

Collectively owned investment accounts have serious disadvantages, however. The disadvantages of mutual funds, for example, are explained at length in U.S. patent application Ser. Nos. 09/038,158 and 09/139,020 and are incorporated herein by reference. Collectively owned accounts also are frequently subject to regulations and/or special accounting and taxation rules. For example, most investment clubs organize as legal partnerships and assign responsibility for their accounting and taxation to the club's treasurer. The treasurer's duties are onerous. Careful accounts must be kept to reflect the fact that different club members might join at different times, contribute different amounts of money, and leave the club at different times. When a club member leaves a club before the other members, the portion of the club's pooled assets allocable to that member are distributed according to these accounts. Also, because the clubs typically are organized as partnerships, they must file partnership tax returns—a form of taxation unfamiliar to most club members. Several software packages have been developed and marketed specifically to investment clubs in an attempt to ease these accounting and taxation burdens.

Another problem with collectively owned investment accounts relates to the possibility of fraud committed by someone who has access to the account's funds. Although reported instances of collectively owned account fraud are rare, the fear of entrusting management over one's money to someone else may preclude some investment clubs from forming, especially when the club members do not know each other or live near each other. As another example, there are significant regulatory and other requirements imposed on mutual funds to attempt to ensure the safekeeping and management of the pooled funds.

Still another problem with collectively owned investment accounts has been that they have been difficult to leave. When a participant in a collectively owned investment account wishes to withdraw his investment, the investment account typically may redeem the investor's interest in cash or in kind.

To redeem in cash, the collectively owned investment account typically liquidates one or more of its investment positions in order to pay the investor the cash value of the investor's interest in the collective account. Redemption in cash, however, has disadvantages. For example, redemption in cash triggers taxation of any appreciation in the investor's initial investment. It may also create tax consequences for the collectively owned account itself and for the investors who retain an interest in the collective account. The impact on other non-redeeming investors is a concern of mutual fund investors who receive unwanted gains distributions in part because of the redemptions of others. In addition, redemption makes it difficult, if not impossible, for the investor to continue to benefit from any of the advantages of the collective account. Redemption in kind has disadvantages as well. Administrative burdens, transaction costs, and the difficulty of dealing with fractional shares of securities have made it generally prohibitive to redeem the investor's interest in kind especially where the collectively owned account has invested in a diversified portfolio. There has also been no way for the investor who redeems to continue to receive the benefits of association with the collective account.

Finally, because of all of these other impacts, it is also difficult for an individual to measure his or her own specific return and risk in a collective investment account, especially when different individuals join or contribute money at different times.

The present invention is therefore directed to the problem of developing a method and apparatus for enabling investors with interests in collectively owned investment accounts to convert those interests into individually owned investment accounts while preserving the option for the investor to continue to benefit from association with the collectively managed investment account.

### SUMMARY OF THE INVENTION

The invention solves these and other problems by providing an interface to an automated portfolio manager system that allows an existing collectively owned investment account to specify its existing assets and the percentage ownership in the account of each of the individual owners of the collective account. The computer in the portfolio manager system then automatically distributes some or all of the collectively owned assets to some or all of the individual owners in proportion to their ownership interest in the collective account, thereby converting some or all of the collective account into individual accounts. The collective account continues to hold information about the assets/liabilities that were in the collective account, even if all of the collective account's assets are distributed to the individual owners. The former owners of the collective account can then continue to collectively manage the residual-master account, or have the residual-master account managed for them, and in either case have the residual-master account linked to the individual accounts so it becomes a “master” account to the individual accounts (which become “slave” accounts).But each slave account can now be managed as a separate account—with its own distinct tax basis, corporate voting and governance opportunities, ability to buy and sell additional securities, ability to contribute additional cash, and ability to monitor risk and return. And it can be managed by a person distinct from that person managing the master account or, as noted below, in connection with the master account.

Each individual who converts his or her interest in the collective account into an individually owned account may continue to receive benefits from association with the collective account. For example, any changes in the residual-master-master collective account can be transmitted to the investor who may either automatically accept them or who may choose to accept, modify or reject them. In this way, investors can enjoy the benefits of association with the collective account without any of the usual accounting burdens, tax disadvantages or fraud concerns.

Finally, members or entities or individuals wishing to add more money to their accounts, or wishing to start new accounts, and thereby become new members or entities or individuals that are connected to the master account, can “join” the collective and have their accounts managed in the same manner as members or entities or individuals that had previously been members of the collective account, or a master account can be established that has no current “slave” accounts and then slave accounts can be added as members or entities or individuals are identified.

### BRIEF DESCRIPTION OF THE DRAWINGS

FIGS. 1A-B depict block diagrams of processes according to various aspects of the present invention.

FIGS. 2-5 depict various exemplary embodiments of computer screens in an exemplary embodiment of a graphical user interface presented to users to convert collectively owned investment accounts to individually owned investment accounts according to one aspect of the present invention.

### DETAILED DESCRIPTION

Any reference herein to “one embodiment” or “an embodiment” means that a particular feature, structure, or characteristic described in connection with the embodiment is included in at least one embodiment of the invention. Use of the phrase “in one embodiment” in various places in the specification is not necessarily all referring to the same embodiment.

As used herein, the phrase “asset/right/liability” refers to any tradable commodity or item of value in which there exists a market, however small, for trading or any security or other commodity that can be divided. Examples include: securities, equities, bonds, futures, mutual funds, hedge funds, investment clubs, derivatives, currencies (both national and foreign), commodities, insurance contracts, mortgages, high-yield debt, foreign debt, convertible debt, notes, pollution rights, development rights, leases, loans, real estate investment trusts, etc. Although the computer-based system of the present invention can be used for any such asset/right/liability, for brevity the discussion herein relates primarily to its use in connection with tradable instruments or securities, and particularly to stocks. The phrase “assets, rights or liabilities” refers to any collection of assets, rights or liabilities.

As used herein, the phrase “manager” refers to any person or group of persons who manages the assets of a collectively owned investment account. For example, a manager can be one member of an investment club or multiple members of an investment club acting in concert. Furthermore, all the members collectively could perform the manager's role. In addition, a manager could be a professional, as in the case of a professional asset manager that is employed by an investment club, mutual fund, or hedge fund. A manager can also be someone whose advice the collective account follows, etc., but who is not actually employed by the collectively owned account. Moreover, a manager can manage one or more collectively owned accounts.

The present invention provides inter alia a method and apparatus for converting a collectively held investment into multiple individual investments, multiple subgroups of collective investments, or any combination of these two types of investments.

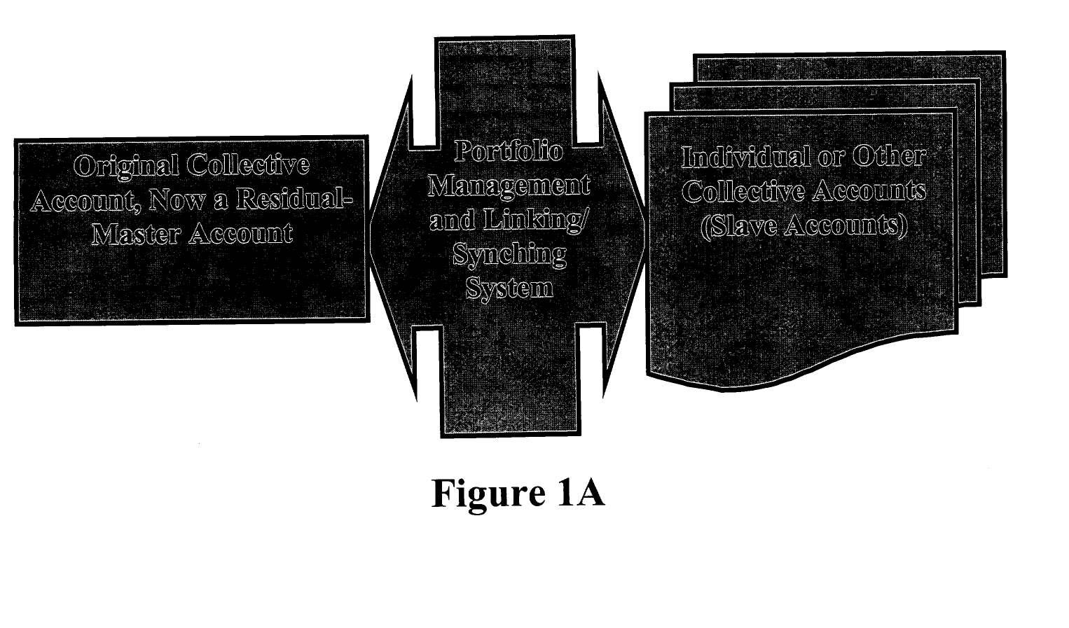

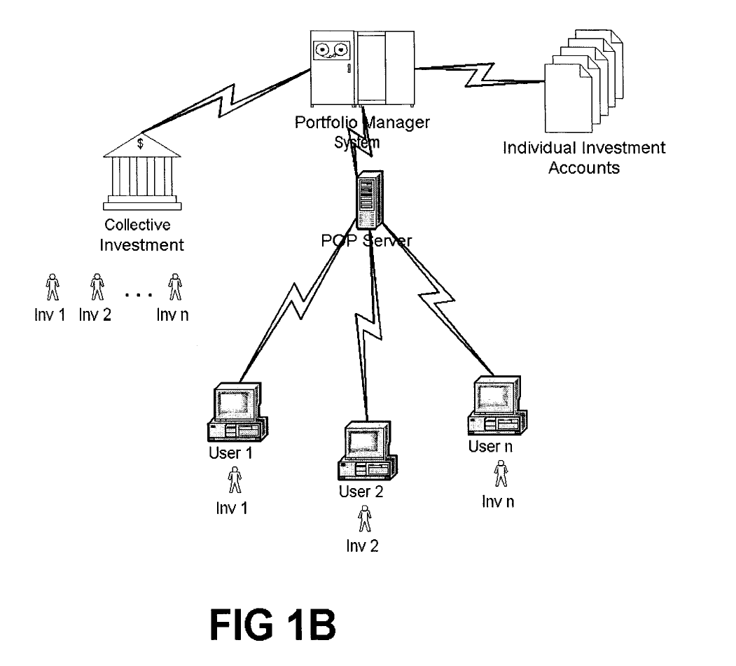

Referring to FIG. 1A, shown therein is a conceptual block diagram of one aspect of the present invention. An original collective investment account is converted to individual investment accounts and/or one or more other “smaller” collective investment accounts and a master residual account, which may include residual assets, rights and/or liabilities as well as investment recommendations and portfolio characteristics. Linking the residual master account to the individual or smaller collective accounts is a portfolio managing and linking/synching system that enables managers of the individual or smaller collective investment accounts to synchronize their portfolios to that retained in the master residual account. As described herein, the synching system enables users inter alia to rebalance their portfolios in accordance with the assets, rights and/or liabilities specified in the master residual account, thereby enabling changes in the master residual account to be implemented in the individual or smaller collective investment accounts either automatically or under the control or authorization of the manager of the individual or smaller collective investment account. This enables inter alia continuation of the original collective investment benefits (e.g., collective investment wisdom) without the inherent disadvantages of a collective investment (e.g., collective ownership).

Referring to FIG. 1B, shown therein is a block diagram according to one aspect of the present invention. A collectively held investment, with investors 1 to n, is transferred to the portfolio manager system, which is described in the related patent applications that have been previously incorporated by reference in their entirety herein, or is maintained at any brokerage, trust or other custodian. Using a technique described subsequently herein, the portfolio manager splits the collective investments into multiple investment accounts, which could be one for each of the investors 1 to −n, or more than one for those investors who wish to have multiple separate accounts or less than one separate account per investor for those investors who wish to maintain their investments in a smaller collective account. For simplicity in the figure, these accounts are depicted as individual accounts, however, one or more of the individual accounts could be multiple accounts for a particular investor or could be a smaller subgroup of the collective, i.e., one or more of these accounts could themselves be a collective investment account for a new group of investors formed from the former owners of the original collective.

For example, one possible implementation of the present invention is to split out one or more individuals from the collective while impacting the individual or collective as minimally as possible. Thus in this example, the original collective continues as a smaller collective, i.e., one or more less members, and one or more individual accounts.

The new individual investors (or a manager of a new group of investors) can then access their accounts using, e.g., a personal computer, that connects to a point of presence (POP) server over a standard communication link, such as a cable modem, dialup modem, local area network, wide area network, public computer network, or the Internet. In such an embodiment, the individual users access a predetermined web site (e.g., http://www.foliofn.com) on the Internet using a standard browser, such as Internet Explorer, or Netscape Navigator.

The user can establish a periodic withdrawal from an account at a bank or other financial institution from his individual account or periodically add to his individual account in this manner. In addition, the user can implement automatic investments based on the periodic contributions, such as purchases on a regular basis of the securities either existing in or comprising by list the residual account (referred to as a “residual-master account” or a “residual-master folio”) (which is discussed supra). These options enable an investor to mechanically follow the residual-master folio with little or no involvement, if desired.

In addition to accessing the portfolio manager system via a website, the system could be embodied in a software program that resides on the user's PC, which enables the user to submit orders to the portfolio manager and which receives data from the portfolio manager system to update the user's program.

In addition, the present invention enables a more sophisticated investor (or an investor with more interest) to make changes to that investor's individual folio to accommodate the investor's specific needs or concerns, such as avoiding socially irresponsible companies, or other companies deemed unacceptable to the individual investor, or to add stocks or other choices that the investor desires, or to combine other investments of the individual with this investment account, or to engage in tax sensitive strategies.

The individual investors 1 to n can now follow investment advice from the collective via the residual-master folio (or from any other manager of the residual-master folio). The residual-master folio includes identification of assets, rights or liabilities and specific weights for these assets, rights or liabilities. The residual-master folio may, but need not, contain actual assets, rights or liabilities. Changes in the residual-master folio are forwarded to the investors: (1) by email alert, instant messaging, or other means; (2) simply when the investor adds additional cash to the individual account linked to the residual-master folio; (3) when a new investor or other investor purchases a newly linked version of the residual-master folio; or (4) automatically by the system, which then allows the investors: (ii) automatically to have their individual accounts updated to the residual-master folio's assets and weights; or (ii) to be able to review and, if found acceptable, accept the changes proposed by the modifications suggested by the change in the residual-master folio; or (iii) have the proposed update to their individual account accepted or not or modified or not in accordance with various rules and algorithms applied to the update (all as described in U.S. Provisional Patent Application No. 60/332,351 entitled “Method and Apparatus for Providing Investment Advice to Multiple Investors” filed Nov. 15, 2001 and U.S. Provisional Patent Application No. 60/333,982 entitled “Method and Apparatus for Rebalancing an Investment Portfolio” filed Nov. 28, 2001). If the collective (or other manager of the residual-master folio) provides a sell or buy recommendation or any other modification to the account, it is accomplished by changing the holdings and/or weightings of the residual-master folio. When a change to the residual-master folio occurs, the owners of the collective are immediately informed or have the opportunity to have their accounts updated automatically or otherwise modified or notified as noted above, thereby enabling them to conform their individual investment accounts to the latest version of the residual-master folio, and to make whatever other changes they may wish to make.

Moreover, such conformations can be implemented automatically if desired by the user. Furthermore, the user can establish further automatic modifications to the residual-master folio, such as replacements for certain undesirable securities, changes in the allocations, etc., yet still be a participant in the collective. If, for example, a user does not prefer to invest in a particular security recommended in the residual-master folio, the present invention enables the user to select a replacement or to reallocate its weight among the remaining investments. Then, the modified folio is stored in the user's area, which is then used for any automatic investments. When a change to the residual-master folio occurs, this change is forwarded to the user, who can then update his or her modified folio based on the changes received.

In addition, the present invention enables each individual member to control its taxable events by controlling when and whether to accept any changes or make any sales from the investor's account. This enables an investor to control if and when the investor incurs a gain or loss and to time such events with other events affecting his tax liability.

The computer-based portfolio investment and management system, to which the present invention applies, is described in detail in the related patent applications cited above. Each of these patents is hereby incorporated by reference as if repeated herein in its entirety, including the drawings. In summary version, the computer-based portfolio manager system enables a user (either an investment club, a manager of an investment club, or any of the investment club's members) to create, manage and trade a diversified portfolio of securities. By investing in a portfolio of securities rather than individual securities, the user may take advantage of modern portfolio theory and obtain a better risk-adjusted return in the long run on average. The computer-based portfolio manager system provides this capability to even a user with small amounts of funds to invest, thereby enabling the user to spread a relatively small investment across many securities in a cost-effective manner. As a result of the present invention, smaller portfolios of securities can be created than might otherwise be economically practical.

The present invention is also very useful in connection even with multi-billion dollar hedge funds that have no concern about small portfolios—but want the ease of administration and tax benefits that this invention provides—especially when combined with the above-mentioned application for managing portfolios of investments.

Embodiments of the portfolio manager system then can aggregate and net orders from individual investors and place one trade, if necessary, in each security as a result of the aggregation and netting, thereby significantly reducing transaction costs. If all orders for trades completely balance against each other, no external trade is necessary.

Alternatively, the embodiments of the system could continuously net orders (without aggregating). This can have the advantage of enabling investors to input orders for trades that are then held until netted against another internal order, thereby ensuring pricing within the bid-ask spread (see below) and also potentially speeding the completion of trades. Such a system could operate in a relatively continuous manner or operate in short increments of time, such as every ten minutes or any other convenient time.

In the embodiments described herein, the user of the portfolio management system can be either the manager of a collectively owned investment account and/or the individual owners of the account to whom the assets/liabilities of the account have been distributed. By setting up a unique password and user identification for the manager of the collectively owned account and another unique password and user identification for each individual owner, the system can easily differentiate between the two types of users and allow differing levels of access and use. Server permissioning capability can be used to authorize certain functions for some users while restricting other users from performing those same functions. For example, the manager of the collectively owned account may be entitled to alter the collectively owned account's portfolio and to grant individual owners of the account the ability to view, research and evaluate the account's portfolio, transaction history and performance.

In contrast, the non-manager owners of the collective account may not be permitted to trade assets/liabilities held by the collective account or to grant access privileges to others. Rather, non-manager owners of the account may have the ability only to view, research and evaluate the account's portfolio, transaction history and performance. Each individual owner would, however, be able to alter the amount of his own investments that are tied to the account's portfolio. Even further, each individual owner would be able to alter the mix of investments so that they depart in one or more respects from the collective account. As a more specific example, an individual owner could decide to link his investments to the collective account except to screen certain stocks or types of stocks that he or she wishes not to own (e.g., Philip Morris or tobacco stocks). Thus, while the collective investment portfolio would be used as a starting position for each member of the collective, the system allows each individual owner to customize the collective portfolio for his or her own purposes.

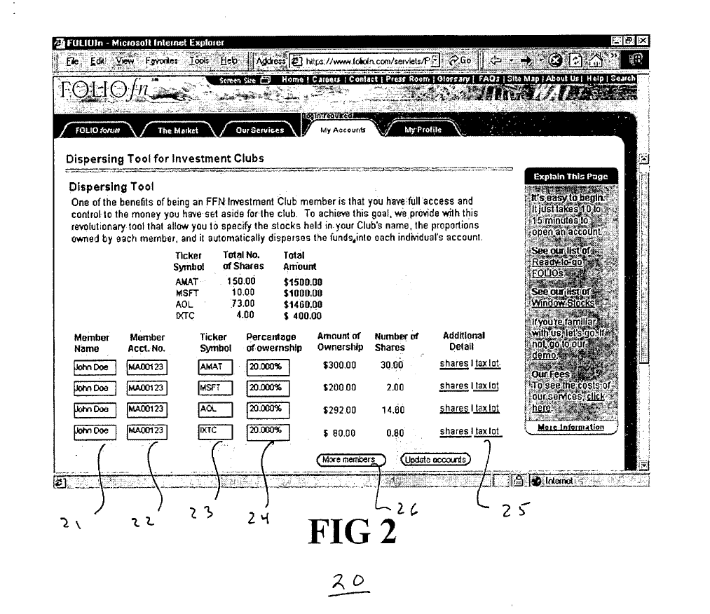

Under an embodiment of the present invention, the collective manager accesses the system to distribute a folio of securities held in the collective account. An exemplary embodiment of a screen from a graphical user interface is depicted in FIG. 2. Shown in FIG. 2 is a dispersing tool 20, which enables the manager to specify on a per asset basis, the percentage ownership of each asset held by the collective. Thus, a field is provided in which the manager can enter the user name 21, account number 22, asset identification 23 and percentage ownership 24. The manager can add additional owners by clicking on the “more members” button 26. The manager can identify specific tax lots for each owner by clicking on the “additional detail” button 25. Once the fields 21-24 are complete, the system automatically calculates the amount of ownership and the number of shares. If necessary, fractional shares are created, or a random allocation or rounding algorithm could be used to provide for whole shares only.

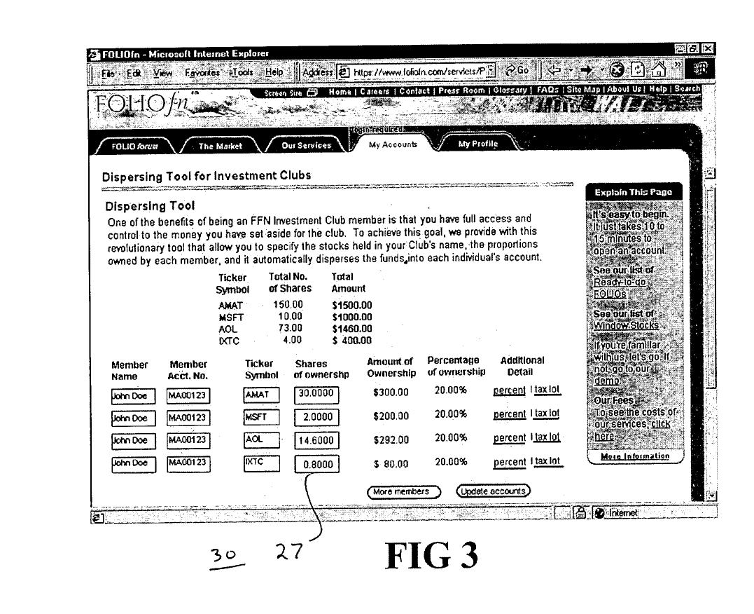

FIG. 3 depicts another exemplary embodiment of a screen 30 used in the graphical user interface similar to that in FIG. 2, except that a field 27 enables the manager to specify the shares of ownership for each user, rather than the percentage ownership, as in FIG. 2. Thus, if the ownership is more easily identified on a per share basis, this embodiment provides the ability to specify ownership in this way.

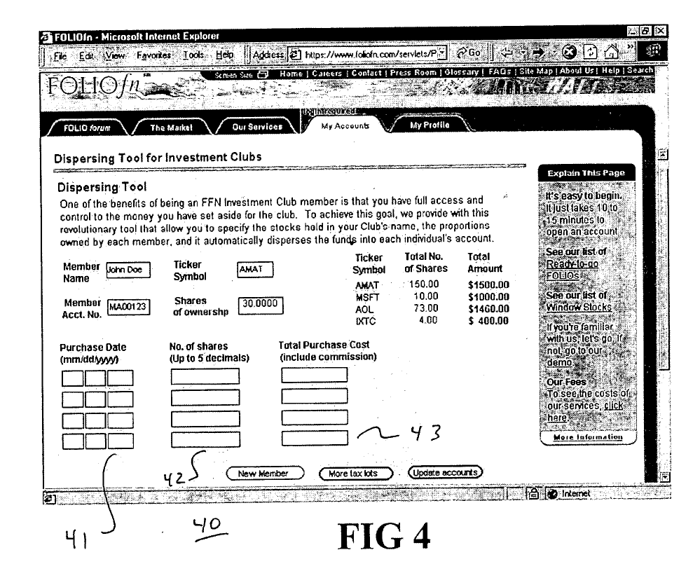

FIG. 4 depicts another exemplary embodiment of a screen used in a graphical user interface for the manager, which enables the manager to enter the assets of the collective on a per owner basis. This embodiment 40 using fields 41-43 enables the manager to specify the basis of the various assets and the purchase date, which is then used to calculate tax liabilities, for example.

The above screens could be modified to allow entry of a percentage basis for ownership over the collective account's assets, from which the system would automatically calculate and dispense the shares accordingly. For example, the screen could allow the assets to be distributed equally on a pro rata basis, or on another specified basis entered by the manager. Once the percentage is specified, the system automatically fills in the assets and the share amounts for each individual owner, which the manager could either confirm or modify.

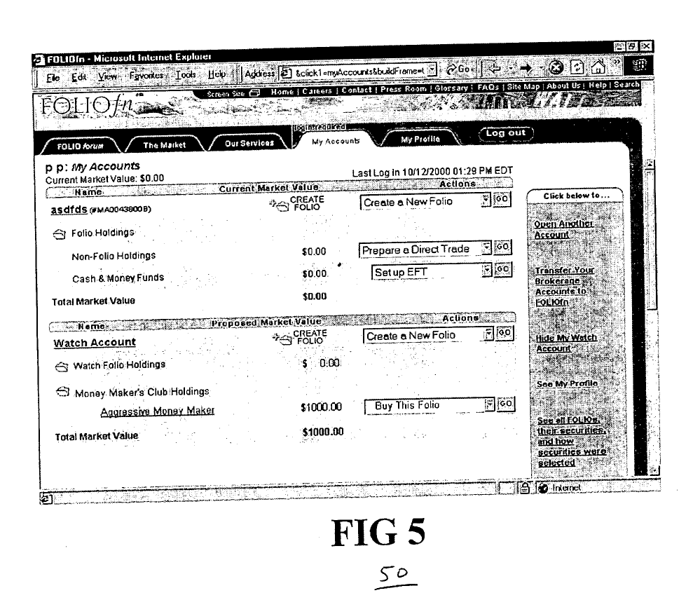

FIG. 5 depicts an exemplary embodiment of the graphical user interface 40 of a manager's account or individual owner's account, from which an individual owner can enter trades, or view his or her holdings.

The manager specifies the proportion of the securities owned by each individual owner of the collective account. The manager also specifies, to the extent not previously recorded, the securities owned by the collective account and any other related information, such as tax lots, etc. The system then creates n+1 folios for the n individual owners of the collective account and one for the collective account itself. The system then distributes the securities from the folio of the collective account into each of the folios for the individual owners in the proper percentages and amounts. The securities are distributed so that: (1) the mix of each of the folios of the individual owners is identical to the mix of the securities in the collective account folio before the distribution; and (2) the value of the securities distributed to each of the folios of the individual owners is proportional to the ownership interest of the respective individual in the collective account.

Once the collective account's securities are distributed to folios belonging to each of the collective account's members, the collective account is left with a residual-master folio. This folio may not contain any actual securities. Rather, the residual-master folio need contain only information—the dollar value of the folio at the time of distribution, the type, amount, and price of the securities and the percentage of the folio that each of the securities represented. This information could be valuable to both the former individual owners of the collective account as well as others.

Collective accounts could be ranked in terms of performance. Users of the system could pay to access the collective account folio to determine its composition (but not the dollar amounts in the respective investments). At least a portion of the fees generated from such access could be forwarded to the respective collective account.

After distribution, the collective account can continue to alter the information in the residual-master folio of the collective account as a result of the account's collective decision-making—or the decision-making of the collective account manager, if the collective account has delegated decision-making authority to the manager. All of the activities of the collective account can continue as before. The only difference is that the collective account no longer holds any assets. From the time of the distribution onward, the collective account is thereby relieved of the bulk—if not all—of its previous accounting and tax reporting obligations.

After distribution, the former individual owners can continue to invest based on their collective knowledge, research and decision-making, or based on the knowledge, research and decision-making of whoever had managed the collective account previously, or of whoever is now authorized to manage the residual-master folio. The former collective owners who are now individual account owners can simply link their own folios to the collective's residual-master folio so that any changes in the weights of the securities in the residual-master folio are automatically made in the individual owner's actual folio, as described above.

Alternatively, other users who have paid to access the collective folio may receive automatic updates. In the case of investment clubs, such users could essentially be shadow members of the club in that they receive the benefit of club membership without joining the club. In return these shadow members pay an access fee for this privilege, a portion of which fee is forwarded to the respective club. If the member does not want to make the changes automatically, the system can notify the member of a change in the club's residual-master folio, and provide the member with the opportunity to decide whether to ignore the changes in the club's residual-master folio or to change his folio to correspond with some or all of the changes in the club's residual-master folio.

As another embodiment, a hedge fund manager that currently runs the fund as a collective can now fractionalize the collective hedge fund and manage separate accounts for each of the former participants in the collective hedge fund. That will allow the manager to add additional members with accounts managed in accordance with the master hedge fund account, or for members to add additional investments or withdraw from the hedge fund management without affecting the other members and without requiring any partnership or other tax effects to be taken into account. It may also provide the opportunity for hedge fund managers to provide their advice and management to a broader base of participants than would otherwise be permitted for regulatory reasons if the assets are all held in a collective investment vehicle with the attendant issues and concerns raised by such vehicles.

After distribution, former individual owners who continue to invest based on the collective's or manager's knowledge, research and decision-making, may also choose to customize their own account or folio to more precisely suit their preferences. For example, a former individual owner may set stock exclusions on his folio so that his folio will match the collective's residual-master folio except that any investment in a particular stock (e.g., Philip Morris) or a particular sector (e.g., tobacco) is excluded and the money that otherwise would have been allocated to that stock is instead either spread across the remaining stocks or invested in a substitute stock identified by the system, the collective, or the former individual owner. As another example, a former individual owner may choose to leverage his folio by buying additional stock within the folio on margin. In the hedge fund context, a manager or the participant owning the separate account can also leverage up or down that particular account, thereby taking on more or less risk than the master hedge fund residual account would have.

The system provides additional benefits to the former individual owners. First, the collective investment decisions will not be affected by the decision of one or more individual owners to leave the collective. Without the system, the collective might have been forced to liquidate securities at a price the collective believed to be unfavorable simply because one individual owner wished to leave. Also, the system provides individual owners with additional security and control over their own investments. In addition, the system allows different individual owners to hold their money in different types of accounts, e.g., IWAs, 401(k) accounts, simple IRAs, taxable individual and joint accounts, etc.

According to an embodiment of the present invention, the graphical user interface used in the above embodiments may be generated by the content server as static displays, such as web pages and the like and delivered to the client terminals for display. In such an embodiment, the static displays may provide boxes or other interactive data input interfaces for entry of data from the individual owners. During operation, customers may enter information for a first screen and indicate to the client terminal when it has completed data entry for the respective screen. Thereafter, the client terminal may deliver the entered data to the content server and receive from the content server a successive static page for further entry. This process may continue until the consumer has completed the data entry process.

According to another embodiment of the present invention, the graphical user interface may be embedded in an executable program, such as a java applet or the like, that may be delivered from the content server to the client terminal. In this embodiment, a client terminal may execute the executable program and dynamically generate displays pursuant to the graphical user interface. The executable program may solicit data from a customer as described above and, when the customer has completed the data entry process, may deliver the entered data to the content server.

The services provided by the present invention may be provided by applications executing on the content server, various client terminals or a combination of both. Consistent with these embodiments, the program instructions of the foregoing embodiments may be stored in a memory provided on the content server, a client terminal or both.

One example of a collective investment is a mutual fund. The present invention could be applied to a mutual fund to enable the investors to obtain the benefits of direct ownership of the underlying securities without the traditional disadvantages. For example, a mutual fund could transfer its collectively owned account to the portfolio manager system, and then use the portfolio manager system to create the individual investment accounts for some or all of the current owners of the shares of the mutual fund. Once created, the fund manager could continue to provide investment advice to the former mutual fund shareholders via the funds' residual-master folio. This would allow the mutual fund to achieve several benefits. First, it would allow the mutual fund to redeem in kind shareholders who wish to redeem shares in the funds. Second, the fund could reduce administrative and regulatory costs associated with servicing mutual fund shareholders. Third, the fund could transfer low cost basis securities to shareholders who wish to redeem in kind and raise the average cost basis of securities left in the residual-master account, thereby reducing the capital gains distribution that may in the future be distributed to the shareholders.

Similarly, with a few changes to account for specific types of collective investments, the present invention can be applied to hedge funds, trusts, investment clubs, 401(k) plans, etc. For example, the present invention could be used to provide a method for easily rolling over one's 401(k) account to an individual IRA account by simply re-designating the status of the individual account and changing the authorization of the individual account so that the individual has control over the investment consistent with IRA requirements or other equivalent retirement account after the transfer, whereas the individual does not have similar control prior to the transfer or rollover.

In addition, the invention allows, for the first time, for a convenient and cost effective means for a roll out from a 401(k) or other plan where participants are ordinarily invested in mutual funds that may not be available outside of the plan. Consequently, when a participant is ready to withdraw from the plan he may have to sell the existing holdings and take the cash to invest in new holdings. With the present invention, a participant could have made available to him the opportunity to “shave off” his investment from the collective interest in the fund and have it managed in a separate non-401(k) distribution account.

Another aspect of the present invention is that complete flexibility is provided when converting a collective investment into individual investments. The methods and systems disclosed herein enable the collective investment to be converted into at least one individual investment and a remaining collective investment or no remaining collective investment and all individual investments, or multiple collective investments and some or none of the individual investments. Thus, each new account created that specifies a percentage of ownership over the collective assets, rights or liabilities could represent one or more members' ownership over the collective investment. Once created, this new collective investment could be subsequently converted into individual investments if preferred by the members of the new collective. Thus, the present invention provides complete flexibility to members to subdivide in any manner suitable to the investors without losing the wisdom of the original collective.

Thus, this aspect of the present invention enables a collective investment to be converted into two or more smaller collective investments. For example, a mutual fund that has become too large can be converted into two smaller funds, each with a different manager to enable the new smaller funds to own larger percentages of certain stocks without violating various laws or regulations.

### SUMMARY

Although various embodiments are specifically illustrated and described herein, it will be appreciated that modifications and variations of the invention are covered by the above teachings and within the purview of the appended claims without departing from the spirit and intended scope of the invention. For example, while several of the embodiments depict the use of specific data management and interface standards, other data management and interfaces will suffice. Moreover, while specific program and protocols are included, other protocols (including subsequently developed protocols) may be sufficient to implement the embodiments described herein. These examples should not be interpreted to limit the modifications and variations of the invention covered by the claims but are merely illustrative of possible variations.

What is claimed is:

1. A method for converting a collective investment into one or more smaller individual or collective investments comprising:
specifying an ownership interest in the collective investment for each of the one or more smaller individual or collective investments; and
splitting the plurality of assets, rights or liabilities in the collective investment among the one or more smaller individual or collective investments in accordance with the specified ownership interest by assigning a fraction of the plurality of assets, rights or liabilities held in the collective investment to each smaller individual or collective investment account, which smaller individual or collective investment account is held separately from the other accounts.

2. The method according to claim 1, further comprising receiving by a third party a plurality of assets, rights or liabilities held by the collective investment, which third party holds the plurality of assets, rights or liabilities collectively for all members of the collective investment.

3. The method according to claim 1, further comprising creating fractional shares as necessary among the plurality of assets, rights or liabilities when said splitting results in less than one share of a particular one of said plurality of assets, rights or liabilities being assigned to said one or more of the smaller individual or collective investment accounts.

4. The method according to claim 1, further comprising maintaining a residual-master portfolio under control of a manager of the collective investment, said residual-master portfolio representing investment recommendations and positions of the collective investment.

5. The method according to claim 4, wherein the residual-master portfolio includes one or more residual-master assets, rights or liabilities of the collective investment.

6. The method according to claim 1, wherein at least one of said one or more smaller collective investments comprises one of: an individual investment or a collective investment or multiples of each or combinations of any of them.

7. The method according to claim 1, wherein said one or more smaller collective investments comprise one or more individual investments.

8. The method according to claim 1, wherein said collective investment comprises a mutual fund.

9. The method according to claim 1, wherein said collective investment comprises an investment club.

10. The method according to claim 1, wherein said collective investment comprises a hedge fund.

11. The method according to claim 1, wherein said collective investment comprises an investment trust.

12. The method according to claim 1, wherein said collective investment comprises a pension plan.

13. The method according to claim 1, wherein said collective investment comprises a first mutual fund and said one or more smaller collective investments comprise a second mutual fund.

14. An apparatus for enabling a collective investment to convert to a plurality of smaller collective or individual investments comprising:
a user interface to assign individual holdings to the plurality of smaller collectives or individuals of the collective investment; and
a processor coupled to the user interface, said processor to split a plurality of assets, rights or liabilities of the collective investment among a plurality of smaller collective investment accounts or individual investment accounts in accordance with the assignments entered via the user interface and to create a residual-master folio from the plurality of assets, rights or liabilities.

15. The apparatus according to claim 14, further comprising a collective investment account to receive a plurality of assets, rights or liabilities of the collective investment;

16. The apparatus according to claim 14, further comprising a client application accessible via a computer network via which the plurality of smaller collectives or individuals from the collective investment can invest additional amounts by purchasing a dollar amount of the residual-master folio or by purchasing in accordance with the assets/liabilities and weights of the residual folio.

17. The apparatus according to claim 14, wherein the user interface further accepts changes to the residual-master folio from an authorized representative of the collective investment, which changes affect subsequent purchases of the residual-master folio.

18. The apparatus according to claim 14, wherein said processor creates fractional shares as necessary among the plurality of assets, rights or liabilities when splitting results in less than one share of a particular one of said plurality of assets, rights or liabilities being assigned to said one or more of the plurality of smaller collective investment accounts or individual investment accounts.

19. The apparatus according to claim 14, wherein said processor maintains a residual-master portfolio under control of a manager of the collective investment, said residual-master portfolio representing investment recommendations and positions of the collective investment.

20. The apparatus according to claim 19, wherein the residual-master portfolio includes one or more assets, rights or liabilities of the collective investment.

21. The apparatus according to claim 14, wherein at least one of said one or more smaller collective investments comprises an individual investment.

22. The method according to claim 14, wherein said one or more smaller collective investments comprise one or more individual investments.

23. A method for converting a collective investment into one or more smaller collective investments comprising:
splitting a plurality of assets, rights or liabilities from the collective investment among the one or more smaller collective investments in accordance with a received specified ownership interest by assigning a fraction of the plurality of assets, rights or liabilities held in the collective trust to a smaller collective investment account for each of the one or more smaller collectives, which smaller collective investment account is held by a third party for each of the one or more smaller collectives; and
maintaining a residual-master portfolio account under control of a manager of the collective investment, said residual-master portfolio account representing investment recommendations and positions of the collective investment.

24. The method according to claim 23, further comprising receiving by a third party a plurality of assets, rights or liabilities held by the collective investment, which third party holds the plurality of assets, rights or liabilities in a collective trust for all members of the collective investment.

25. The method according to claim 23, further comprising linking each of the one or more smaller collective investments to the residual-master portfolio.

26. The method according to claim 23, further comprising enabling a manager of each of the one or more smaller collective investments to synchronize the one or more smaller collective investments in accordance with the residual-master portfolio.

27. The method according to claim 23, further comprising modifying the residual-master portfolio and rebalancing at least one of the one or more smaller collective investments in accordance with the residual-master portfolio after the modifications.
